(19) United States
(12) Patent Application Publication
(10) Pub. No.: US 2005/0027497 A1
(43) Pub. Date: Feb. 3, 2005

(54) Method for calculating the impact behavior of a fluid-filled container

(76) Inventors: Sven Kretzschmar, Wetter (DE); Zlatko Penzar, Frankfurt (DE); Bernd Rumpf, Nidderau (DE)

Correspondence Address: Richard A. Speer;MAYER, BROWN, ROWE & MAW LLP, P.O. Box 2828, Chicago, IL, 60690-2828, US

(21) Appl. No.: 10/869,302

(22) Filed: Jun. 16, 2004

(30) Foreign Application Priority Data
Jun. 17, 2003 (DE) 10327506.1

(51) Int. Cl. G06G 7/48

(52) U.S. Cl. 703/9

(57) ABSTRACT

In the case of a method for calculating the impact behavior of a fluid-filled container, characteristic numbers and/or physical values of a solid body are used for the fluid, and the characteristic numbers and/or physical values are approximated to those of a fluid. This results in greatly simplifying the calculation of the impact behavior of the container.

### BACKGROUND OF THE INVENTION

The invention relates to a method for calculating the impact behavior of a fluid-filled container, in particular a method for calculating the crash behavior of a motor vehicle fuel tank which is filled with fuel, in which the strength and the deformation of a wall of the container is calculated as a function of the dynamic behavior of the fluid in the container.

Such calculation methods are frequently used in practice in computer simulations and are known, for example, as the CFD code (CFD=Computational Fluid Dynamics). These calculations are intended to be used to determine, for example, the manner in which the wall of the container is deformed and is possibly destroyed. This enables, for example, a container drop test to be simulated.

A disadvantage of the known method is that the simulation of the behavior of closed containers which are filled with fluid is associated with considerable computational effort and, in the case of a computer simulation, with considerable numerical stability problems. The cause of this is the interplay of a simulation of the flows in the fluid with a calculation of strength for the wall of the container.

The invention is based on the problem of designing a method of the type mentioned at the beginning in such a manner that it can be carried out particularly easily and the numerical effort is kept particularly low.

### BRIEF DESCRIPTION OF THE INVENTION

This problem is solved according to the invention by characteristic numbers and/or physical values of a solid body being used for the fluid, and by the characteristic numbers and/or physical values being approximated to those of a fluid.

This design enables the calculation of the crash behavior to be substantially simplified, since, instead of a CFD code, the fluid is modeled by a solid body. This makes it possible to use both generally known explicit and also implicit FE codes (Finite-Element codes), the calculation of which proceeds substantially more rapidly and stably. The numerical effort can therefore be kept particularly low.

According to one advantageous development of the invention, the movements of the fluid assumed as the solid body can be simulated in a simple manner if a particularly low value is used for the shear modulus of the solid body. This value may be virtually zero, but just low enough to enable the algorithm to still run with sufficient stability. This also permits the behavior of the body in a gravitational field or in a centrifuge to be calculated.

Since liquids, like solid bodies, are virtually incompressible, according to another advantageous development of the invention, an error in the calculation can be kept particularly small if values of the fluid are used as the compression modulus and as the density of the solid body.

According to another advantageous development of the invention, the maximum loading of the container wall can be determined in a simple manner in a container drop test if a value is used for the compression rigidity of the solid body which is substantially greater than the value of the compression rigidity of the container.

According to another advantageous development of the invention, the errors in the calculation are further reduced if an algorithm preventing the solid body from penetrating the container wall is selected. This takes into consideration the fact that, under real conditions of the fluid-filled container, the liquid does not penetrate the container wall.

The method according to the invention turns out to be particularly simple in the case of a half full container if characteristic numbers and/or physical values of a solid body are used for a gas layer situated above the fluid in the container, and if the characteristic numbers and/or physical values are approximated to those of a fluid.

### BRIEF DESCRIPTION OF THE DRAWINGS

The invention permits numerous embodiments. To further clarify its basic principle one of these is illustrated in the drawing and is described below. In the drawing

FIG. 1 shows a fluid-filled container before an impact,

FIG. 2 shows the fluid-filled container after the impact.

### DETAILED DESCRIPTION OF THE INVENTION

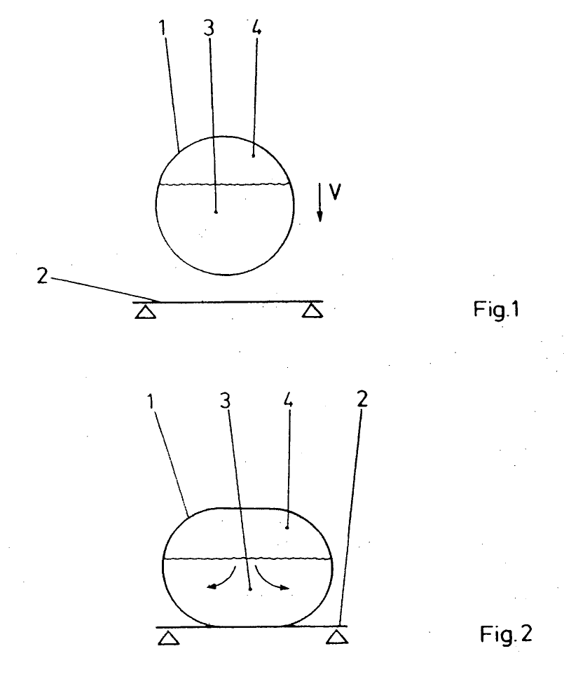

FIG. 1 shows a sectional illustration through a container, for example a fuel tank for a motor vehicle, having a spherical wall 1 (illustrated in a simplified manner). The container moves at a speed V toward a rigid barrier 2. The lower part of the container is filled with a liquid 3 while there is air 4 above the liquid.

When the container arrives against the barrier 2, the inertia of the liquid 3 and of the air 4 causes them to be pushed toward the barrier 2. This position is illustrated in FIG. 2. In the process, the wall 1 of the container is deformed.

The method according to the invention approximates characteristic numbers and/or physical values of the liquid 3 and of the air 4 to those of a solid body. Physical values of the solid body are selected to correspond to those of a liquid, with the result, for example, that a particularly low value is assumed as the shear modulus.

1. A method for calculating the crash behavior of a motor vehicle fuel tank which is filled with fuel, in which the strength and the deformation of a wall of the container is calculated as a function of the dynamic behavior of the fluid in the container, characterized in that the calculation is carried out using the characteristic numbers and/or physical values of a solid body are used in place of those for a fluid, and in that the characteristic numbers and/or physical values of the solid body are approximated to those of a fluid.

2. The method as claimed in claim 1, characterized in that a particularly low value is used for the shear modulus of the solid body.

3. The method as claimed in claim 1 or 2, characterized in that values of the fluid are used as the compression modulus and as the density of the solid body.

4. The method as defined in claim 1, characterized in that for the compression rigidity of the solid body a value is used which is substantially greater than the value of the compression rigidity of the container.

5. The method as defined in claim 1, characterized in that an algorithm preventing the solid body from penetrating the container wall is selected.

6. The method as defined in claim 1, characterized in that characteristic numbers and/or physical values of a solid body are used for a gas layer situated above the fluid in the container, and in that the characteristic numbers and/or physical values are approximated to those of a fluid.
